(19) United States
(12) Patent Application Publication
(10) Pub. No.: US 2010/0111659 A1
(43) Pub. Date: May 6, 2010

(54) RACKING APPARATUS FOR A VEHICLE AND METHOD

(76) Inventor: SERGE OUELLET, Squatec (CA)

Correspondence Address: OGILVY RENAULT LLP, 1, Place Ville Marie, SUITE 2500, MONTREAL, QC, H3B 1R1, CA

(21) Appl. No.: 12/612,948

(22) Filed: Nov. 5, 2009

(30) Foreign Application Priority Data
Nov. 5, 2008 (GB) 0820189.9

(51) Int. Cl. B60R 9/08; B60P 3/10; B60R 9/06

(52) U.S. Cl. 414/462; 414/812

(57) ABSTRACT

A racking apparatus for use with a motor vehicle, the racking apparatus comprises a support frame adapted to support an object to be carried by the vehicle. A mechanism has one end attached to a rear portion of the motor vehicle and another end attached to a load support frame to connect the support frame to the motor vehicle, the mechanism comprising members and joints arranged to constrain movements of the support frame such that the mechanism is operable to reciprocably displace the support frame between a low position accessible to a person from the ground and a high position overhanging the motor vehicle.

### CROSS-REFERENCE TO RELATED APPLICATION

This application claims priority on United Kingdom Patent Application No. 0820189.9, filed Nov. 5, 2008.

### FIELD OF THE APPLICATION

The present application relates generally to motor vehicles and, more particularly, to a racking apparatus for use in carrying objects with the motor vehicle.

### BACKGROUND OF THE ART

Racking devices for racking items for transport onto a vehicle are known in the art and are popular for instance amongst sports enthusiasts who want to carry, in an easy and stable manner, voluminous sports items such as, for examples, a fishing boat, a jet ski, a kayak, bicycles, etc., in a piggyback fashion on the top portion of a motor vehicle such as a car, etc.

Racking devices generally include roof-racks or trailers. Roof-racks consist in a structure that is anchored to the roof of the vehicle, with a support frame designed to support specific objects. Roof-racks are typically not very ergonomic, because they may be quite difficult to reach for certain people. Roof-racks generally require a person to extend his or her arms to place the object on the roof of the vehicle. This may make objects difficult to manipulate, and may require undue strength or effort on the part of the person.

Trailers comprise another form of racking device. Trailers are hitched to a rear portion of the vehicle. However, trailers are typically voluminous and may limit how a vehicle is used or render the vehicle mode difficult to drive. For example, it may be difficult for a vehicle to travel on rough terrain while pulling a trailer. In addition, having a trailer may make it more difficult to drive or park the vehicle.

Noticeable examples of the prior art are U.S. Patent application No. 2007/0090139, to R. McKenzie (2007), U.S. Pat. No. 6,336,411, to S. C. Gates (2002), U.S. Pat. No. 6,357,991, to C. L. Hamlett (2002), U.S. Pat. No. 5,108,248, to R. E. Murril (1992), U.S. Pat. No. 3,612,366, to H. J. Schneider (1971), and U.S. Pat. No. 3,550,800, to W. E. Robinson (1970).

While these prior art devices generally offer a racking devices which allow the racking of an object onto the rear end portion of a transport vehicle, they also present a number of disadvantages. Prior-art devices generally entail inconvenient frame structures and/or mechanisms which require to be fixed at a number of positions in or around the rear end portion of the transport vehicle. This requirement often leaves the rear end portion of the transport vehicle, i.e. for example, the trunk of a car or the cargo bed of a pick-up truck, inaccessible for stowing and retrieving items. Prior art devices are also generally designed for a specific shape of a rear portion of a vehicle such as, for example, the rear trunk of a sedan car, the cargo bed of a pick-up truck, the high rear cab of a hatchback car or mini-van, etc. These prior art devices therefore lack versatility and may only be used in certain specific situations.

### SUMMARY

It is therefore an aim of the present disclosure to provide a racking apparatus that addresses issues associated with the prior art.

In one embodiment, there is provided a racking apparatus for use with a motor vehicle, the racking apparatus comprising: a support frame adapted to support an object to be carried by the vehicle; and a mechanism having one end attached to a rear portion of the motor vehicle and another end attached to the support frame to connect the support frame to the motor vehicle, the mechanism comprising members and joints arranged to constrain movements of the support frame such that the mechanism is operable to reciprocably displace the support frame between a low position accessible to a person from the ground and a high position overhanging the motor vehicle.

In another embodiment, there is provided a method for racking an object over a vehicle with a support frame connected to the vehicle by a mechanism, the method comprising: loading an object onto the support frame when the load support frame is in a low position accessible to a person standing on the ground; securing the object to the support frame; raising the support frame with the use of the mechanism to a high position overhanging the vehicle, the high position being higher than the low position; and locking the mechanism such that the support frame is blocked in the high position overhanging the vehicle.

### DESCRIPTION OF THE DRAWINGS

Reference is now made to the accompanying figures, in which:

FIG. 1 is a side elevational view of a racking apparatus according to one embodiment of the present disclosure, here shown releasably fastened to a hitch receiver frame of a vehicle, in a low position accessible to a person;

FIG. 2 is a side elevational view of the embodiment of FIG. 1, shown here with an object in a transport position overhanging the vehicle;

FIG. 3 is a top plan view of a load support frame assembly of the racking apparatus, as seen in the embodiment shown in FIGS. 1 and 2; and

FIG. 4 is a top plan view of an adjustable wheel assembly of the racking apparatus, as seen in the embodiment shown FIGS. 1 and 2.

### DETAILED DESCRIPTION OF THE PREFERRED EMBODIMENTS

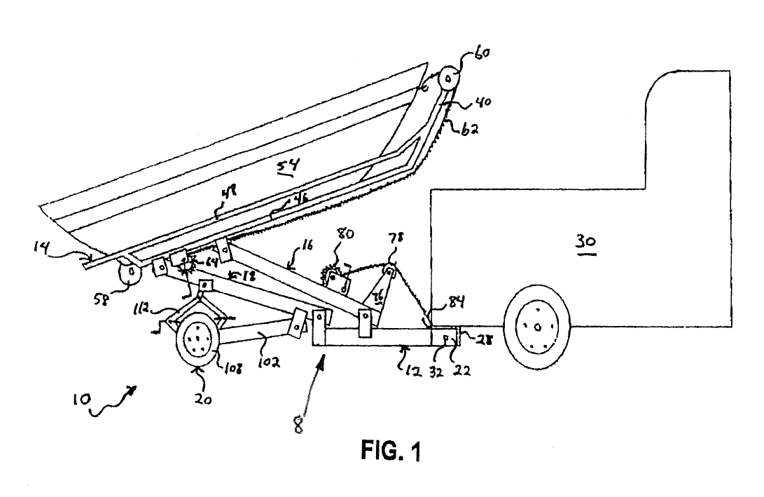

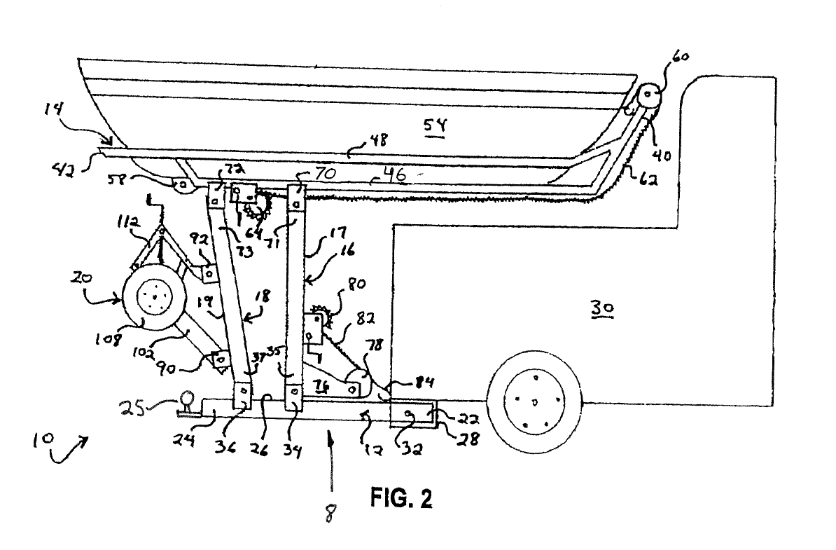

FIGS. 1 and 2 show one embodiment of the racking apparatus 10 of the present disclosure. The racking apparatus 10 generally comprises a mechanism 8 having one end 22 attached to a rear portion of a motor vehicle 30 and another end 71 attached to a load support frame assembly 14. The mechanism 8 is operable to reciprocably displace the load support frame assembly 14 between a low position accessible to a person and a high position overhanging the vehicle 30.

The mechanism 8 generally comprises a central mounting member 12 and at least one leg member 16 having an end 35 connected to the central mounting member 12, and an opposite end 71 connected to the load support frame assembly 14. In the embodiment shown, the mechanism 8 comprises two leg members, a first leg member 16 and a second leg member 18, which are connected to the central mounting member 12 and to the load support frame assembly 14, and which are longitudinally spaced apart with respect to the central mounting member 12 and the load support frame assembly 14, so as to form a four-bar linkage mechanism. In other embodiments, the mechanism 8 may have only one leg member or may have more than two leg members. In one embodiment, it may be desirable for the mechanism to comprise two leg members, in addition to the load support frame assembly and the central mounting member. This may allow the mechanism to comprise a four-bar linkage with parallel members, i.e. a parallelogram linkage, which may permit the central mounting member 12 and the load support frame assembly 14, to be in selected orientations with respect to one another.

In the embodiment shown, the central mounting member 12 is represented by an elongated hollow member generally defined as having a proximal end 22, a distal end 24 (e.g., with a hitch-ball mount 25, as seen in FIG. 2) and an upper side surface portion 26. In one embodiment, the proximal end 22 has a substantially square cross-section that may be slidably coaxially mounted within a compatibly configured square open end of a common hitch receiver frame 28 of a motor vehicle 30. The proximal end of central mounting member 12 may be releasably fastened within the hitch receiver frame 28 with a locking pin 32 inserted in corresponding transversal holes provided therethrough, or with any other suitable locking mechanism. In other embodiments, the proximal end may be of another shape and may be received by a compatible hitch receiver frame 28. The proximal end 22 may additionally be attached by any suitable conventional means previously known in the art. In another embodiment, the proximal end 22 of the central mounting member is attached directly to the chassis of the vehicle, without requiring the addition of an accessory to the vehicle 30. In another embodiment, the central mounting member 12 may be a non-hollow member, such as a cast solid.

The first leg member 16 has an end 35 which is pivotally connected to the central mounting member 12 through a first pivot support means 34 which is located at a roughly mid-longitudinal position along the upper side surface portion 26 thereof. The second leg member 18 has an end 37 which is pivotally connected to the central mounting member 12 through a second pivot support means 36 which is located at a substantially midway position between the first pivot support means 34 and the distal end 24 on the upper side surface portion 26 thereof. Both the first and second pivot support means 34 and 36 are for pivotally mounting on a transverse horizontal axis the ends 35 and 37 of the first and second leg members 16 and 18 respectively. In other embodiments, the location of the first pivot support means 34 and the second pivot support means 36, on the central mounting member 12 may be different than in the embodiment shown, without departing from the scope of the present application.

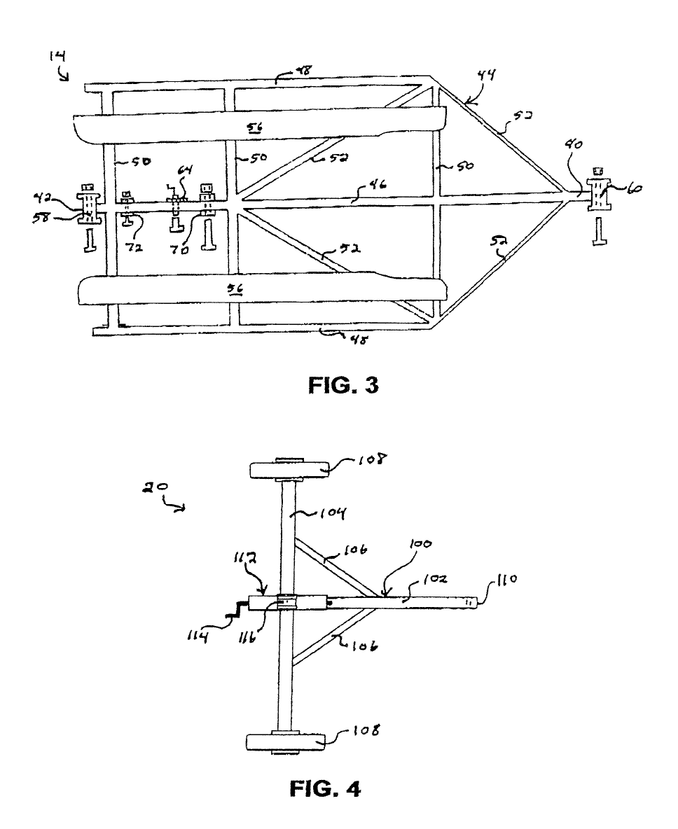

FIG. 3 shows a top plan view of the load support frame assembly 14 that is generally defined as having a front end 40 and a rear end 42. The load support frame 14 generally comprises a base frame assembly 44 having a plurality of elongated members generally involving a spine member 46 extending substantially the length of the base frame assembly 44 and a pair of substantially parallel side members 48 equidistantly, transversely spaced on each side of the spine member 46. A plurality of transversely and diagonally oriented cross-members 50, 52 are rigidly interconnecting the spine member 46 with each side member 48.

Furthermore, as best illustrated in FIG. 2, the elongated portion of the pair of parallel side members 48 occupy a slightly offset parallel plane relative to the spine member 46, such that an elongated cradle, or concave-shaped configuration is thus created for stably supporting therein an object to be carried, which for example, can be a generally elongated and laterally convex underside shape of a single-hull boat 54.

Within the concave portion of the load support frame 14, there is provided a pair of elongated plank-shaped members 56 that are longitudinally oppositely disposed in a parallel configuration at a roughly mid-transversal position between the spine member 46 and the side members 48. The plank-shaped members 56 are preferably formed of a resilient material such as, for example, plastic resin, suitably treated wood planks or aluminum U-shaped struts, which may be covered by a cushioning synthetic fabric, a foam or another absorbent material, to cushion the hull and protect the hull finish from the rigid surface of the members. It is to be understood that the general shape and size of the plank-shaped members 56 may be varied to stably support different particular objects.

At the front end 40 of the load support frame assembly 14, the spine member 46 and diagonally adjoining cross-members 52 converge towards one another at an upwardly and forwardly oriented angle of roughly 45 degree relative to the general horizontal plane of the cradle-shaped portion of the load support frame 14.

Referring concurrently to FIGS. 1 to 3, a keel roller 58 is centrally rotatably mounted on a transverse horizontal axis at the distal rear end 42 of the base frame assembly 44 for supporting and rollably guiding the keel portion of a boat 54 during loading and unloading operations of the latter on the racking apparatus 10.

The distal end of the front end 40 of the base frame assembly 44 is provided with a cable roller 60 rotatably mounted on a transverse horizontal axis for rollably guiding a cable 62 having one end which may be releasably hooked or otherwise releasably attached to an object, such as a boat 54, and the other end passing round the cable roller 60 and extending along the underside of the spine member 46, to a cable hoist assembly 64 rigidly fastened to a rear end underside portion thereof. As seen in FIGS. 1 and 2, the cable 62 may be attached, using for example a hook arrangement or any other conventional attachment means, to the object, such as a boat 54, so as to secure the object on the load support frame assembly 14. Furthermore, the cable hoist assembly 64 may be operated so as to pull the cable 62, the cable thereby also pulling on the object, in order to load the object, such as a boat 54, onto the load support frame assembly 14.

The cable roller 60 at the front end 40 of the frame assembly 44 may also serve as a conventional bow stop roller for stopping the forward motion of a boat during loading and transport of the boat on the racking apparatus 10. The rotatable wheels of both the keel roller 58 and cable roller 60 are preferably made of a resilient shock-absorbing material, such as rubber.

The first leg member 16 has an opposite end 71 which is pivotally connected to the load support frame assembly through a third pivot support means 70 which is located on an underside portion of the spine member 46 on rear portion thereof. Similarly, the second leg member 18 has an opposite end 73 which is pivotally connected to the load support frame assembly 14 through a fourth pivot support means 72 which is located on an underside portion of the spine member 46 on a rear portion thereof, between the first pivot support means 70 and the rear end 42 of the spine member 46.

In the arrangement shown, the leg members 16 and 18 and joints of the mechanism 8 constrain movement of the support frame assembly 14 between a low position (FIG. 1) and a high overhanging position (FIG. 2). In the low position, the support frame assembly 14 is slanted with respect to the ground, for instance to facilitate loading a boat onto the support frame assembly 14. In the high overhanging position, the support frame assembly 14 is generally parallel to the ground, for instance to reduce the drag of the vehicle and racking apparatus 10 supporting an object. It is pointed out that other orientational relations may be used between the two afore-mentioned positions. For instance, the support frame assembly 14 may be at all times parallel to the ground. The orientational relations are selected by the sizing of the members and the positioning of the joints in the mechanism 8, to constrain the movement of the support frame assembly 14.

In the embodiment shown, the load support frame assembly 14 has been described as pertaining to a boat. However, in other embodiments, the load support frame assembly 14 may comprise various other configurations compatible with different sorts of object. For instance, the load support frame assembly 14 may be configured to be compatible for bicycles, all-terrain vehicles, kayaks, canoes, jet-skis, cargo transportation, etc.

Furthermore, although the load support frame assembly 14 has been described as using a cable 62 with a hook arrangement to secure the object thereon, the load support frame assembly may comprise various other locking systems to secure the object thereon. For instance, the locking system may comprise a quick release locking system for a bike fork, a rope and knot attachment system, a chain and bolt system, a key and lock system, or various other locking systems previously known in the art.

In the embodiment shown, an elongated support bracket 76 is perpendicularly projecting from a portion of an upper side surface 17 of first leg member 16, in proximity of the end 35 thereof. A cable roller 78 is rotatably mounted on a transverse horizontal axis of the distal end of the support bracket 76. A cable hoist assembly 80 is rigidly attached to a portion of the upper side surface 17 of the first leg member 16. A cable 82 extends from the cable hoist assembly 80, passes around the distal circumference of the cable roller 78 and has its distal end releasably attached, using any suitable attachment means, such as a hook 84 arrangement, or the like, to a portion of the upper side surface portion 26 of the central mounting member 12 and substantially near the proximal end 22 thereof. In other embodiments, the attachment means may comprise other conventional attachment means known in the art, such as a pin, a fastener, etc.

The pivotable first and second leg members 16, 18, in cooperative relation with the cable hoist assembly 80, the bracket 76 and cable roller 78 attached to the first leg member 16, and cable 82 attached to the central mounting member 12, serve as a pivotable load transfer means for transferring the load support frame assembly 14 from a low position accessible to a person, as illustrated in FIG. 1, to a higher position overhanging the vehicle 30, as illustrated in FIG. 2. In order to displace the load support frame assembly 14 to a higher position, as seen in FIG. 2, the cable hoist assembly 80 is operated and the cable 82 pulls the leg member 16 to a substantially vertical position. In order to displace the load support frame assembly 14 to a low position, as seen in FIG. 1, the cable hoist assembly 80 is released and the cable 82 supports the leg member 16 while moving to a rearward leaning position. In order to maintain the mechanism 8 in either positions, the cable hoist assembly 80 may be locked, so as to prevent displacement of the load support frame assembly. Other locking mechanisms may be used as well to ensure that the support frame assembly 14 is safely locked into the low and high positions. For instance, a ratchet system (e.g., a two-way ratchet system) may appropriately be used.

It is to be noted that the leg members 16 and 18 are of suitable length such that when the load support frame assembly 14 is in an high position overhanging the vehicle 30, as seen in FIG. 2, the underside of the latter sufficiently clears the top rear end portion of an average size transport vehicle 30 such as, for examples, the cargo bed of a pick-up truck or the rear trunk of a car. This provides the load support frame 14 with a relatively high overhanging position above the rear end portion of the vehicle once the racking apparatus is in a transport configuration. This relatively high overhanging position of the load support frame assembly 14, in addition to the single point of attachment of the racking apparatus 10 to the hitch receiver frame 28 of the vehicle 30, allow a user to have a relatively free access at all times to the rear trunk or cargo bed of a transport vehicle, such as for example, a sedan car or a pick-up truck. This also allows the towing of a trailer by the motor vehicle 30, for instance using the hitch-ball mount 25 (FIG. 2).

Although the cable hoist assemblies 64 and 80 mentioned above have been illustrated as being of the manually operated type, it is to be understood that any other suitable types of power drive means may be used to operate the hoists such as, for example, electrical or hydraulic power drive means. In another embodiment, the racking apparatus 10 uses a ratchet system to pivot the leg members 16,18 with respect to the central mounting member, as opposed to using a cable hoist assembly 80. In addition, other means of operating the racking apparatus, such as a gear chain system or a hydraulic system, may be used in place of cable hoist assemblies. Moreover, the members of the mechanism 8 may be balanced with counterweights, for the manually unaided displacement of the support frame assembly 14 between the low and high positions. These means of operating the racking apparatus may be used by most people and may not require undue strength.

In the embodiment shown, the first pivot support means 34 of the central mounting member 12 is positioned at a suitable distance from the proximal end 22 thereof for allowing the support bracket 76 and cable roller 78 perpendicularly projecting from the first leg member 16 to abut in a substantially parallel configuration against the upper side surface portion 26 of the central mounting member 12 when the first leg member 16 is pivoted vertically in a perpendicular configuration relative to the central mounting member 12, as illustrated in FIG. 2. In another embodiment, the support bracket 76 and cable roller 78 may be further spaced apart from the proximal end 22 of the central mounting member 12, such that they need not abut the upper side surface portion 26 thereof.

As shown in FIGS. 1 and 2, an adjustable wheel assembly 20 may be mounted to an underside surface portion 19 of the second leg member 18. This adjustable wheel assembly 20 allows the racking apparatus 10 to tow an object behind the vehicle, such as in a standard trailer device, thereby greatly increasing the versatility of the racking apparatus. Now referring to FIG. 4, the adjustable wheel assembly 20 generally comprises a substantially T-shaped frame 100 defined by a longitudinal member 102, a transversal member 104, and reinforcing diagonal members 106 joining the two members 102, 104. In other embodiments, the T-shaped frame 100 may comprise other functional shapes, such as a triangle for example.

A pair of tire mounted wheels 108 are oppositely rotatably mounted at each distal end of the transversal member 104. The distal end 110 of the longitudinal member 102 is pivotally coupled to a fifth pivot support means 90 projecting from the underside surface 19 of the second leg member 18, in proximity to end 37. In another embodiment, the distal end 110 of the longitudinal member 102 may be connected to a pivot support means (not shown) located at the distal end 24 of central mounting member 12.

A conventional manually operated scissor jack 112, as best illustrated in FIGS. 1 and 2, with a rotatable handle 114 oriented oppositely of the longitudinal member 102, has an end 116 pivotally connected to a sixth pivot support means 92 projecting on the underside surface 19 of the second leg member 18. The scissor jack 112 has an opposite end (not shown) pivotally mounted to a corresponding pivot support means (not shown) projecting from a portion of the T-shaped frame 100, where the members 102 and 104 intersect.

With the racking apparatus 10 attached to the hitch receiver frame 28 of the motor vehicle 30 and the load support frame assembly 14 suitably positioned in a loading configuration, e.g. a low position accessible to a person, as illustrated in FIG. 1, the user may adjust the vertical height of the scissor jack 112 in order to have the pair of wheels 108 stably resting on the ground, independently of the height of the substantially horizontal central mounting member 12 relative to the ground. The adjustable wheel assembly 20 therefore allows a person to adjustably lower to the ground the pair of tire mounted wheels 108 which offer a temporary distal rear end support when the load support frame assembly 14 is being loaded with an object. When the object has been loaded onto the load support frame assembly 14 and the load support frame assembly 14 is raised to a higher position overhanging the vehicle 30, the adjustable wheel assembly 20 may be engagedly raised upwardly by the scissor jack 112, along with the leg members 16, 18 and thus, is no longer in contact with the ground, as seen in FIG. 1.

In addition, instead of directly attaching the proximal end 22 of the central mounting member 12 to the hitch receiver frame 28 of a motor vehicle 30, a ball-hitch coupler (not shown) may be attached to the proximal end 22 of the mounting member 12 such that the racking apparatus 10 may be coupled to a standard hitch ball mount at the rear of the motor vehicle for towing the racking apparatus 10 in a standard two-wheeled trailer configuration, as seen in FIG. 2. The racking apparatus is therefore easily convertible to a standard two-wheeled trailer by simply attaching a ball hitch coupler to the proximal end 22 of the central mounting member 12. In the embodiment shown in FIGS. 1 and 2, it may be necessary to leave the load support frame assembly 14 in a loading configuration, i.e. a low position accessible to a person, as seen in FIG. 2, in order to use the racking apparatus 10 as a towable trailer. In another embodiment, the racking apparatus 10 may be used as a towable trailer when the load support frame assembly 14 is in a higher position, such as for example, when the load support frame assembly 14 is overhanging the vehicle 30.

It should be noted that when a ball hitch coupler is attached to the proximal end 22 of the central mounting member 12, the racking apparatus 10 may additionally be used with various other types of motor vehicles, including smaller sport utility vehicles, such as an All Terrain Vehicle (ATV). This enables the present disclosure to be used on various trips or activities, wherein a change of vehicles may be involved, such as for example, a truck carrying the racking apparatus 10 over a certain distance, the racking apparatus then being transferred to an All Terrain Vehicle.

The adjustable wheel assembly 20 may allow the racking apparatus 10 to be used to stably support the rear end 42 of the racking apparatus 10 when, for example, a relatively heavy load, comparatively to the weight of the transport vehicle 30, is hoisted onto the load support frame assembly 14 using the cable hoist assembly 64, followed by the raising of the load support frame assembly 14 to the higher transport position overhanging the vehicle 30, by winding the cable hoist assembly 80 attached to the first leg member 16. In such a case, the adjustable wheel assembly 20 may provide the additional benefit of counterbalancing the front to rear weight distribution applied to the vehicle 30 when a relatively heavy object is hoisted thereon.

It is to be noted that the adjustable wheel assembly 20 may be removed entirely from the racking apparatus 10 since the hoisting of an object generally does not noticeably affect the front to rear weight balance of the transport vehicle 30 while the object 54 is hoisted and transferred above the rear end portion of the latter.

The present disclosure may be used with only a single point of attachment between the racking apparatus and the vehicle 30, which renders the racking apparatus quickly and easily installable on a wide range of transport vehicles having various rear end sizes and shapes including, but not limited to, sedan cars, hatchback cars, pick-up trucks, mini-vans, etc.

The various structural members of the racking apparatus 10 are preferably made of suitably rigid material such as extruded aluminum struts or rust-proof metal. It is to be noted that the pivot support means 34, 36, 70, 72, 90 and 92 may comprise various types of constraint joints. The simplicity of the structure and of the members and constraints involved provides for a racking apparatus which is relatively simple and economical to produce.

Now that the racking apparatus 10 has been described, a method of racking an object with the racking apparatus 10 is set forth.

According to a first step, a person loads the object onto the load support frame assembly 14, when the load support frame assembly 14 is in a low position accessible to a person. The low position involve ergonomically-efficient movements from the person. The loading may be done manually or may be done by using the cable hoist assembly 64, or another alternative loading means thereof. Alternatively, the object may be loaded onto the load support frame assembly 14 when the load support frame assembly 14 is in a high position, for instance overhanging the vehicle 30. However, it may be less ergonomic to load the object when the load support frame is in a high position. Therefore, in a preferred embodiment, the loading is done when the load support frame assembly 14 is in a low position (FIG. 1), easily accessible to a person.

The person subsequently secures the object onto the load support frame assembly 14, using attachment means thereof, for instance using a cable 62 and hook arrangement, or other known attachment means in case of a watercraft, or a bike rack or the like in other instances. Alternatively, the step of securing the object to the load support frame assembly 14 may be done simultaneously with the previous step of loading the object onto the load support frame assembly 14, or may be done after the support frame assembly 14 is raised to the high position (FIG. 2).

The following step includes raising the load support frame assembly 14 into a high position, higher than the low position, either manually or with a power-assist system as described above. In one embodiment, this high position may comprise a position which is overhanging the vehicle 30. The raising of the load support frame assembly 14 is done with the use of the mechanism 8. For instance, the mechanism 8 may include operating means thereof, which raise the load support frame assembly 14 to a higher position. In one embodiment, the mechanism 8 may include a central mounting member 12, leg members 16, attached to said central mounting member 12 and operating means thereof, the operating means being operated to actuate the pivoting of the leg members 16,18 with respect to the central mounting member.

In one embodiment, the operating means may comprise the cable hoist assembly 80 or a ratchet system. In an alternative embodiment, the step of raising the load support frame assembly 14 may be done prior to the step of securing the object to the load support frame assembly 14. In such a case, the object may be secured to the load support frame assembly 14 after the load support frame assembly 14 has been raised to a high position. However, this embodiment may be less ergonomically efficient in that it may be more difficult to secure the object to the load support frame assembly 14 when the load support frame assembly 14 is in a position higher than the low position accessible to a person.

The person subsequently locks the mechanism 8 using locking means thereof, when the load support frame assembly 14 is in a high position overhanging the vehicle 30. In one embodiment, the mechanism 8 may be locked by using locking means to maintain the leg members 16, 18 in a position which minimizes movement thereof. The locking means may comprise the cable hoist assembly 80 and the cable 82 being locked in a given position, such that minimal movement of the cable 82 is permitted. In another embodiment, the locking means may include a self-locking ratchet system. The locking of the mechanism 8 serves to maintain the load support frame assembly 14 in a substantially stable and constant position, so long as the mechanism is locked. In other embodiments, the mechanism 8 may be locked when the load support frame assembly is in a position other than that overhanging the vehicle. For instance, the leg members 16, 18 may be locked when the load support frame assembly 14 is in a low position accessible to a person.

According to a subsequent step, a trailer may be attached to the vehicle using the hitch-ball mount 25 (FIG. 2), when the support frame assembly 14 is in the high position.

Although the above description contains many details, these should not be construed as limitations on the scope of the invention but as merely providing one illustration of the presently preferred embodiment of this disclosure. For example, the first and second leg members 16, 18 may be represented by telescopically adjustable elongated members to custom-adjust the desired height and angle of the load support frame assembly 14 relative to the top rear end portion of a transport vehicle.

1. A racking apparatus for use with a motor vehicle, the racking apparatus comprising:
a support frame adapted to support an object to be carried by the vehicle; and
a mechanism having one end attached to a rear portion of the motor vehicle and another end attached to the support frame to connect the support frame to the motor vehicle, the mechanism comprising members and joints arranged to constrain movements of the support frame such that the mechanism is operable to reciprocably displace the support frame between a low position accessible to a person from the ground and a high position overhanging the motor vehicle.

2. The racking apparatus as defined in claim 1, wherein one of the members of the mechanism is a mounting member matingly attached at a first end to a hitch system of the vehicle.

3. The racking apparatus as defined in claim 2, wherein the mounting member has a hitch-ball mount at a second end for hitching a trailer to the hitch-ball mount while the support frame supports an object in the high position.

4. The racking apparatus as defined in claim 1, further comprising operating means connected to the mechanism to actuate the displacement of the support frame between the low position accessible to a person and the high position overhanging the motor vehicle.

5. The racking apparatus as defined in claim 1, wherein the support frame includes attachment means securing the object to the support frame.

6. The racking apparatus as defined in claim 5, wherein the attachment means comprises a cable, the support frame having a cable roller on a front portion thereof through which the cable passes and a cable hoist assembly on an underside portion thereof where the cable extends, the cable hoist assembly being operated to pull the cable in order to load the object onto the load support frame.

7. The racking apparatus as defined in claim 1, wherein the mechanism has a mounting member adapted to be connected to the motor vehicle, and two leg members mounted by pivot joints at opposed ends to the mounting member and to the support frame to form a four-bar linkage.

8. The racking apparatus as defined in claim 7, wherein the pivot joints and leg members are arranged to constrain the mechanism (1) to orienting the support frame in a slanted condition with respect to the ground in the low position, and (2) to orienting the support frame to a parallel condition with respect to the ground in the high position.

9. The racking apparatus as defined in claim 1, further comprising a locking mechanism for locking the mechanism in at least the high position of the support frame.

10. The racking apparatus as defined in claim 1, wherein the mechanism comprises at least one leg member, the at least one leg member having an adjustable wheel assembly attached thereon, the adjustable wheel assembly including a frame and at least two oppositely mounted wheels contacting the ground when the support frame is in the low position.

11. The racking apparatus as defined in claim 10, wherein the adjustable wheel assembly includes extension means, the extension means allowing the adjustable wheel assembly to be in a deployed or retracted position.

12. The racking apparatus as defined in claim 11, wherein when the adjustable wheel assembly is deployed, the wheels touch the ground such that the loading assembly is used as a wheeled trailer.

13. The racking apparatus as defined in claim 11, wherein the extension means comprises a scissor jack which is attached to the at least one leg member and the frame, the scissor jack being operated to extend the adjustable wheel assembly away from the at least one leg member or to retract the adjustable wheel assembly towards the at least one leg member.

14. The racking apparatus as defined in claim 1, wherein the mechanism includes a first end being slidably mounted within a coaxial part of a hitch receiver frame of the motor vehicle, and a locking pin being inserted through transversal holes therethrough.

15. The racking apparatus as defined in claim 1, wherein the mechanism comprises a ball-hitch coupler attachable to a standard hitch-ball mount located at the rear portion of the vehicle.

16. A method for racking an object over a vehicle with a support frame connected to the vehicle by a mechanism, the method comprising:
loading an object onto the support frame when the load support frame is in a low position accessible to a person standing on the ground;
securing the object to the support frame;
raising the support frame with the use of the mechanism to a high position overhanging the vehicle, the high position being higher than the low position; and
locking the mechanism such that the support frame is blocked in the high position overhanging the vehicle.

17. The method as defined in claim 16, wherein loading the object onto the support frame further comprises actuating a cable hoist pulling on the object until the object is loaded onto the support frame.

18. The method as defined in claim 16, wherein raising the support frame comprises operating an activated system so as to raise the support frame from the low position to the high position.

19. The method as defined in claim 16, wherein raising the support frame with the use of the mechanism to a high position overhanging the vehicle comprises raising the support frame from a slanted condition with respect to the ground to a parallel condition with respect to the ground.

20. The method as defined in claim 16, further comprising attaching a trailer to a rear end of the mechanism when the support frame is in the high position.
